(19) United States
(12) Patent Application Publication
(10) Pub. No.: US 2014/0164239 A1
(43) Pub. Date: Jun. 12, 2014

(54) ACCOUNT BORROWING SYSTEM AND METHOD

(71) Applicants: Hon Hai Precision Industry Co., Ltd., New Taipei (TW); Hong Fu Jin Precision Industry (Shenzhen) Co., Ltd, Shenzhen (CN)

(72) Inventor: JUN-NAN FAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/900,558

(22) Filed: May 23, 2013

(30) Foreign Application Priority Data
Dec. 11, 2012 (CN) 2012105301538

(51) Int. Cl. G06Q 20/10

(52) U.S. Cl. CPC G06Q 20/10
USPC 705/44

(57) ABSTRACT

An account borrowing system includes at least one client operated by a first user and a second user and a server. The processor includes a communication module, to receive an account borrowing request submitted by the first user using the at least one client. A forwarding module forwards the account borrowing request to the second user using the at least one client. A linking module obtains the account information of the second user from a storage unit and generate a super link address for accessing a login page of the account of the second user when the second user approves the account borrowing request. In addition, a communication module transmits the supper link address to the first user using the at least one client.

### BACKGROUND

1. Technical Field

The present disclosure relates to account borrowing systems and methods, and particularly to an account borrowing system and method for one-time borrowing of an account.

2. Description of Related Art

Different accounts with networked resources often have different authorizations for certain function. If certain accounts which do not have the authorization to use some function, it would not be convenient for the user if he/she wants to use the function.

Therefore, it is desirable to provide an account borrowing system and method, which can overcome the above-mentioned problem.

### BRIEF DESCRIPTION OF THE DRAWINGS

FIG. 1 is a functional block diagram of account borrowing system, according to a first embodiment.

FIG. 2 is a flowchart showing a method for one-time borrowing an account using the account borrowing system of FIG. 1.

### DETAILED DESCRIPTION

Embodiments of the disclosure will be described with reference to the accompanying drawings.

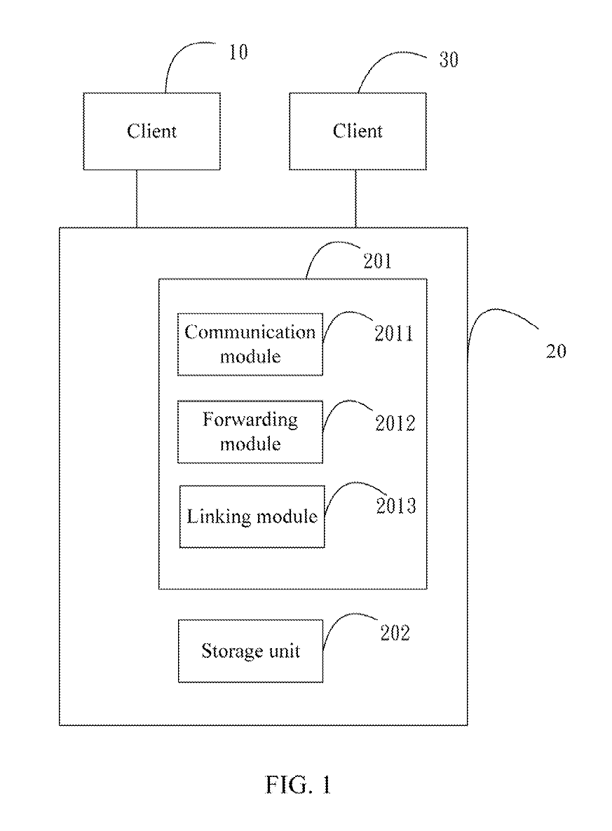

FIG. 1 is an account borrowing system of one embodiment. The account borrowing system includes a server 20 and two clients 10, 30. The account borrowing system can be implemented by hardware, software modules, or combination thereof. The client 10 is operated by a first user and the client 30 is operated by a second user.

In other embodiments, only one client is employed and both the first user and the second user. The server 20 includes a processor 201 and a storage unit 205. The storage unit 205 stores a database recording all user's account information, for example, such as, names of the accounts, and associated passwords and authorizations.

The processor 201 includes a communication module 2011, a forwarding module 2012, and a linking module 2013.

The communication module 2011 is configured to receive an account borrowing request submitted by the first user at the client 10.

The forwarding module 2012 is configured to forward the account borrowing request to the second user at the client 30. The second user can approve or reject the account borrowing request at the client 30. In other embodiments, the forwarding module 2012 is also configured to search accounts that can satisfy the account borrowing request and forward the account borrowing request to the searched accounts.

The linking module 2013 is configured to detect if the second user approves the account borrowing request. If yes, the liking module 2013 obtains the account information of the second user from the storage unit 205, generates a super link address for accessing a login page of the account of the second user. The super link address can be a one-time link to ensure account security for the second user. For example, the names of the account of the second user, and associated password are already inputted in the login page.

The communication module 2011 is configured to transmit the super link address to the first user at the client 10

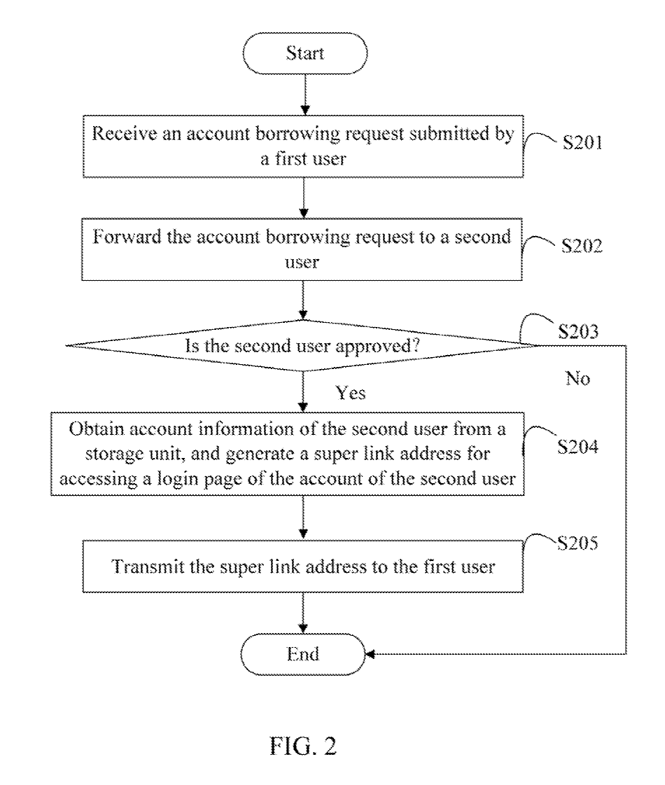

FIG. 2 is a flowchart showing a method for the one-time borrowing an account using the account borrowing system of FIG. 1.

In the step S201, the communication module 2011 receives the account borrowing request submitted by the used A at the client 10.

In the step S202, the forwarding module 2012 forwards the account borrowing request to the second user at the client 30.

In the step S203, the linking module 2013 detects whether the second user approves the account borrowing request, if yes, the procedure goes to the step S204, otherwise, the procedure ends.

In the step S204, the linking module 2013 obtains the account information of the second user, and generates a super link address for accessing the login page of the account of the second user.

In step S205, the communication module 2011 transmits the super link address to the first user at the client 10.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An account borrowing system comprising:
at least one client to be operated by a first user and a second user; and
a server comprising a storage unit and a processor, the storage unit storing a database recording all user's account information;
wherein the processor comprises a communication module, to receive an account borrowing request submitted by the first user using the at least one client;
a forwarding module, to forward the account borrowing request to the second user using the at least one client;
a linking module, to obtain the account information of the second user from the storage unit and generate a super link address for accessing a login page of the account of the second user when the second user approves the account borrowing request; and
a communication module, to transmit the supper link address to the first user using the at least one client.

2. The account borrowing system according to claim 1, wherein the super link address is a one-time link to ensure account security for the second user.

3. The account borrowing system according to claim 1, wherein the account borrowing system is implemented by hardware, software modules, or combination.

4. The account borrowing system according to claim 1, wherein a number of the at least one client is one, and the first user and the second user operate same client.

5. The account borrowing system according to claim 1, wherein a number of the at least one client is two, and one client is operated by the first user and another client is operated by the second user.

6. The account borrowing system according to claim 1, wherein the forwarding module searches accounts that satisfies the account borrowing request and forwards the account borrowing request to the searched accounts.

7. An account borrowing method comprising:
receiving an account borrowing request submitted by a first user using a first client;
forwarding the account borrowing request to the second user using a second client;
obtaining account information of the second user from a storage unit and generating a super link address for accessing a login page of the account of the second user when the second user approves the account borrowing request; and
transmitting the supper link address to the first user using the first client.

8. The account borrowing method according to claim 7, wherein the super link address is a one-time link to ensure account security for the second user.

9. The account borrowing method according to claim 7, wherein the account borrowing method is implemented by hardware, software modules, or combination.

10. The account borrowing method according to claim 7, further comprising searching accounts that satisfies the account borrowing request and forwards the account borrowing request to the searched accounts.

11. An account borrowing method comprising:
receiving an account borrowing request submitted by a first user using a client;
forwarding the account borrowing request to the second user using the client;
obtaining account information of the second user from a storage unit and generating a super link address for accessing a login page of the account of the second user when the second user approves the account borrowing request; and
transmitting the supper link address to the first user using the client.

12. The account borrowing method according to claim 11, wherein the super link address is a one-time link to ensure account security for the second user.

13. The account borrowing method according to claim 11, wherein the account borrowing method is implemented by hardware, software modules, or combination.

14. The account borrowing method according to claim 11, further comprising searching accounts that satisfies the account borrowing request and forwards the account borrowing request to the searched accounts.
